(19) United States
(12) Patent Application Publication
(10) Pub. No.: US 2002/0148283 A1
(43) Pub. Date: Oct. 17, 2002

(54) Apparatus for measuring viscosity

(76) Inventor: Yau-Dong Chang, Chang Hwa Hsien (TW)

Correspondence Address: WILDMAN, HARROLD, ALLEN & DIXON, 225 WEST WACKER DRIVE, CHICAGO, IL, 60606, US

(21) Appl. No.: 09/836,513

(22) Filed: Apr. 17, 2001

(51) Int. Cl. G01N 11/14

(52) U.S. Cl. 73/54.32

(57) ABSTRACT

An apparatus for measuring viscosity of a sample of material includes a mold assembly, a rotor assembly, and a torque measuring device. The mold assembly includes upper and lower mold members that cooperate to form a chamber to hold the sample of material therein. The upper mold member includes an outer mold portion formed with a mold opening to receive an inner mold portion therein such that the inner mold portion is surrounded by the outer mold portion and is movable relative to the outer mold portion. The rotor assembly includes a rotor shaft having a first end portion coupled to a rotor member in the chamber and a second end portion that extends through a shaft hole in the lower mold member, and a drive unit coupled to the second end portion of the rotor shaft. A torque measuring device measures the amount of torque induced by the sample of material on the inner mold portion.

### BACKGROUND OF THE INVENTION

1. Field of the Invention

The invention relates to an apparatus for accurately measuring the viscosity of rubber or similar polymeric materials.

2. Description of the Related Art

Rubber and other similar polymeric material, such as EVA, are extensively used in the shoe-making industry. The viscosity of such materials is an important factor that must be considered during the formation process. FIG. 1 illustrates a conventional apparatus, commonly known as a Mooney Viscometer, for measuring viscosity. The apparatus includes lower and upper mold members 1, 2. The lower mold member 1 is disposed on a base 3, and confines a lower mold cavity 101. The lower mold member 1 is formed with an upwardly extending mold periphery 101′ and a shaft hole 102 that is communicated with the lower mold cavity 101. The upper mold member 2 is disposed on a frame 4 above the lower mold member 1, and confines an upper mold cavity 201. The upper mold member 2 is formed with a downwardly extending mold periphery 201′. The mold peripheries 201′, 101′ of the upper and lower mold members 2, 1 abut tightly against each other to form a chamber (A) that is adapted to hold the sample of material to be tested therein. A rotor member 6 is disposed in the chamber (A). Both the chamber (A) and the rotor member 6 have roughened surfaces. A rotor shaft 5 has a first end portion coupled non-rotatably to the rotor member 6, and a second end portion that extends through the shaft hole 102 in the lower mold member 1. A drive unit 7 is coupled to the second end portion of the rotor shaft 5 for driving the rotor shaft 5 to rotate, thereby driving the rotor member 6 to rotate in the chamber (A). A seal ring 8 is sleeved on the rotor shaft 5 and is retained in the shaft hole 102 such that an inner periphery of the seal ring 8 is in sealing contact with the rotor shaft 5. A torque measuring device 9 is coupled to the second end portion of the rotor shaft 5 and measures the amount of torque induced on the rotor shaft 5 by the sample of material that is held in the chamber (A) when the rotor member 6 rotates in the chamber (A).

In use, after filling the chamber (A) with the sample of material to be tested, the drive unit 7 is activated to drive the rotor shaft 5 and the rotor member 6 to rotate. The upper and lower mold members 2,1 are kept stationary at this time. Thus, during rotation of the rotor member 6, the sample of material that adheres to the surface of the rotor member 6 rotates relative to the sample of material that adheres to the cavity-defining surfaces of the upper and lower mold members 2, 1, thereby inducing a torque on the rotor shaft 5. The amount of torque produced is then measured by the torque measuring device 9 and is used to determine the viscosity of the sample of material.

Indeed, the viscosity of a sample of material to be tested can be determined using the aforesaid conventional apparatus. However, since the torque measuring device 9 is coupled to the second end portion of the rotor shaft 5, the amount of torque measured includes not only the torque attributed to the sample of material in the chamber (A), but also the torque induced due to friction between the seal ring 8 and the rotor shaft 5. Assuming that the torque produced by the seal ring 8 is a constant, then the viscosity obtained using the conventional apparatus is not affected. However, in actual practice, since the seal ring 8 might be eccentrically located relative to the rotor shaft 5, and since the seal ring 8 is susceptible to deformation due to long-term use or to compression forces applied by the sample to be tested, the torque applied on the rotor shaft 5 and attributed to the seal ring 8 cannot be maintained at a constant, thereby leading to the imprecise measurement of the viscosity of the sample.

### SUMMARY OF THE INVENTION

Therefore, the main object of the present invention is to provide an apparatus for accurately measuring the viscosity of rubber or similar polymeric materials to overcome the aforesaid drawbacks commonly associated with the prior art.

Accordingly, the apparatus of the present invention comprises a mold assembly, a rotor assembly, and a torque measuring device. The mold assembly confines a chamber that is adapted to hold the sample of material to be tested therein. The mold assembly includes upper and lower mold members. The lower mold member confines a lower mold cavity, and is formed with an upwardly extending mold periphery and a shaft hole that is communicated with the lower mold cavity. The upper mold member is disposed above the lower mold member and confines an upper mold cavity that cooperates with the lower mold cavity to define the chamber. The upper mold member includes an inner mold portion and an outer mold portion that is formed with a mold opening to receive the inner mold portion therein such that the inner mold portion is surrounded by the outer mold portion and is movable relative to the outer mold portion. The outer mold portion has a downwardly extending mold periphery that abuts tightly against the upwardly extending mold periphery of the lower mold member to form the chamber when the mold assembly is closed. The rotor assembly includes a rotor member disposed in the chamber, a rotor shaft having a first end portion coupled non-rotatably to the rotor member and a second end portion that extends sealingly through the shaft hole in the lower mold member, and a drive unit coupled to the second end portion of the rotor shaft for driving the rotor shaft to rotate, thereby driving the rotor member to rotate in the chamber such that the sample of material to be tested induces a torque on the inner mold portion of the upper mold member. The torque measuring device is coupled to the inner mold portion of the upper mold member for measuring the amount of torque induced by the sample of material on the inner mold portion of the upper mold member when the rotor member rotates in the chamber. The viscosity of the sample of material in the chamber can be determined from the amount of torque measured by the torque measuring device.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional schematic side view of a conventional apparatus for measuring the viscosity of a material;

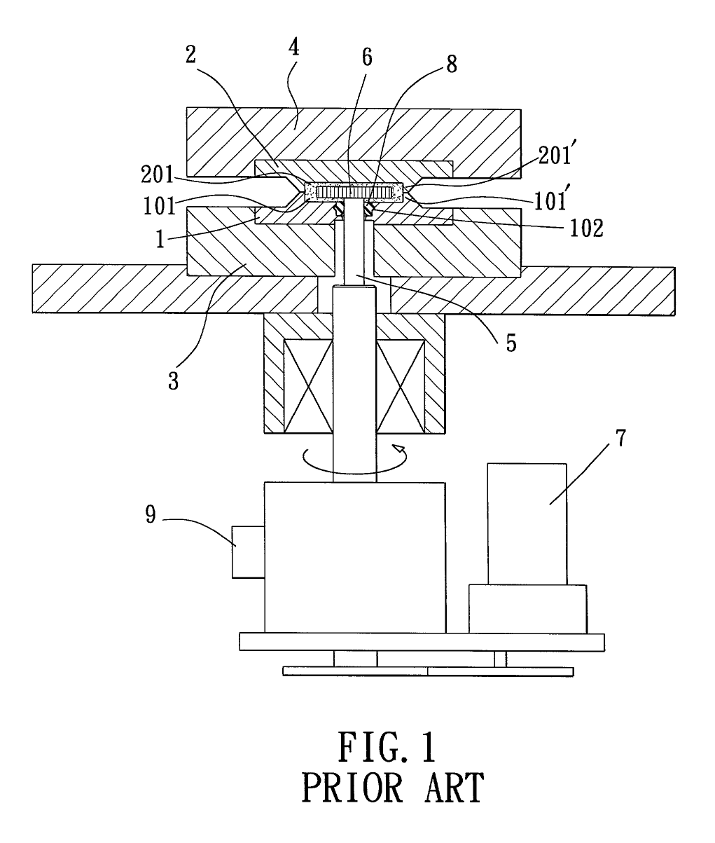

FIG. 2 is a sectional schematic side view of the preferred embodiment of an apparatus for measuring the viscosity of a material according to the present invention; and

FIG. 3 is an enlarged sectional schematic side view of the preferred embodiment of the present invention.

### DETAILED DESCRIPTION OF THE PREFERRED EMBODIMENT

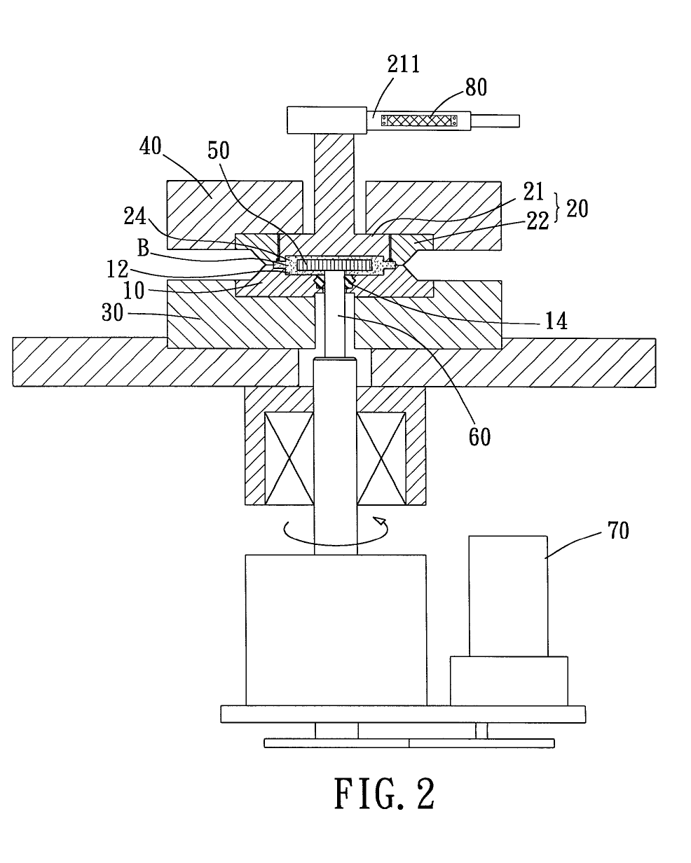

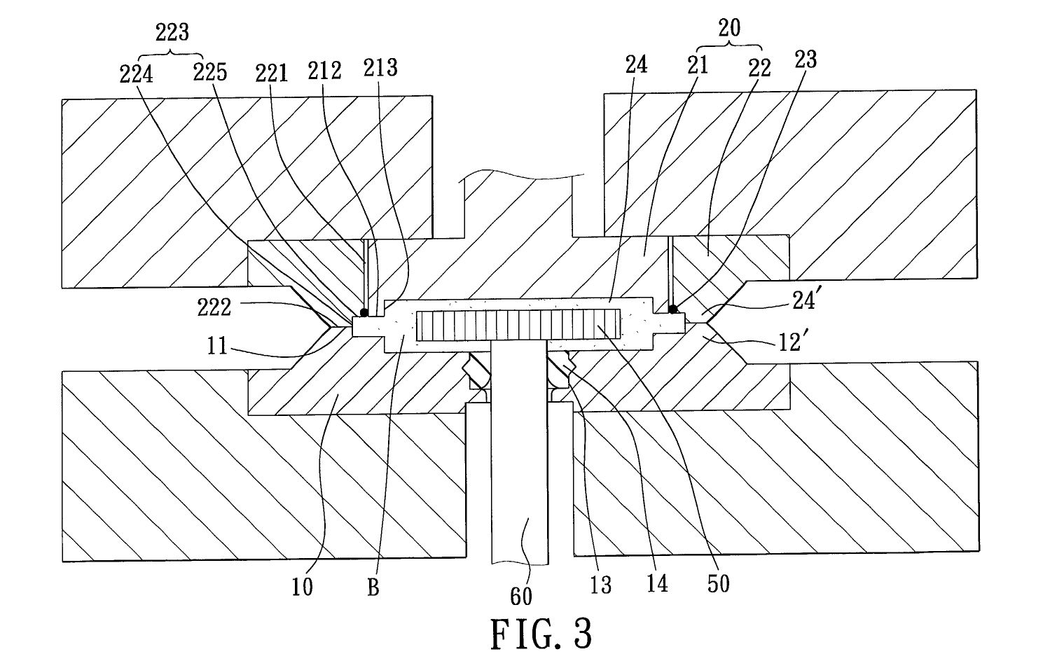

Referring to FIGS. 2 and 3, the preferred embodiment of the apparatus of the present invention is shown to include a mold assembly, a rotor assembly, and a torque measuring device 80.

The mold assembly confines a chamber (B) that is adapted to hold a sample of material to be tested therein. The mold assembly includes lower and upper mold members 10, 20. The lower mold member 10 is disposed on a base 30, and confines a lower mold cavity 12. The lower mold member 10 is formed with an upwardly extending mold periphery 12′ with an end face 11, and a shaft hole 13 that is communicated with the lower mold cavity 12. The upper mold member 20 is disposed on a frame 40 above the lower mold member 10, and confines an upper mold cavity 24 that is complementary to and that cooperates with the lower mold cavity 12 to define the chamber (B) The upper mold member 20 includes an inner mold portion 21 and an outer mold portion 22 that is formed with a mold opening 221 to receive the inner mold portion 21 therein such that the inner mold portion 21 is surrounded by the outer mold portion 22 and is movable relative to the outer mold portion 22. A seal ring 23 is disposed between the inner and outer mold portions 21,22 to prevent the sample of material to be tested from entering into the mold opening 221. The outer mold portion 22 has a downwardly extending mold periphery 24′ with an end face 222 that abuts tightly against the end face 11 of the upwardly extending mold periphery 12′ of the lower mold member 10 to form the chamber (B) when the mold assembly is closed. The outer mold portion 22 has a cavity-defining wall 223 that includes an axial wall portion 224 and a radial wall portion 225. The end face 222 is disposed radially and outwardly relative to the radial wall portion 225. The inner mold portion 21 has an end face 212 and an axial surface 213. The end face 212 is disposed radially and outwardly relative to the axial surface 213, and is flush with the radial wall portion 225.

The rotor assembly includes a rotor member 50 disposed in the chamber (B), a rotor shaft 60 having a first end portion coupled non-rotatably to the rotor member 50 and a second end portion that extends through the shaft hole 13 in the lower mold member 10, and a drive unit 70 coupled to the second end portion of the rotor shaft 60 for driving the rotor shaft 60 to rotate, thereby driving the rotor member 50 to rotate in the chamber (B). Both the rotor member 50 and the chamber (B) have roughened surfaces. A seal ring 14 is sleeved on the rotor shaft 60 and is retained in the shaft hole 13 such that an inner periphery of the seal ring 14 is in sealing contact with the rotor shaft 60.

The inner mold portion 21 of the upper mold member 20 is formed with a lateral beam 211. The torque measuring device 80, such as a known strain gauge, is coupled to the lateral beam 211.

In use, after filling the chamber (B) with the sample of material to be tested, the upper and lower mold members 20, 10 are brought to close the mold assembly. The drive unit 70 is then activated to drive the rotor shaft 60 and the rotor member 50 to rotate. Since the upper and lower mold members 20,10 are kept stationary, and since the rotor member 50 and the chamber (B) have roughened surfaces, the sample of material that adheres to the surface of the rotor member 50 will rotate relative to the sample of material that adheres to the surface of the chamber (B). A friction force will thus be induced on the surface of the chamber (B). According to Newton's third law of motion, i.e. the action force is equal to the reaction force, the friction force acting on the entire surface of the chamber (B) is equal to the friction force acting on the surface of the rotor member 50. Since the friction force is directly proportional to the friction area, when the amount of torque acting on the inner mold portion 21 of the upper mold member 20 is measured by the torque measuring device 80, the measured amount of torque can be divided by the fraction of the surface area occupied by the inner mold portion 21 relative to the entire surface area of the chamber (B), thereby resulting in a measure of the amount of torque applied on the surface of the chamber (B), which is also equivalent to the amount of torque induced on the surface of the rotor member 50. The viscosity of the sample of material can thus be determined through the amount of torque measured by the torque measuring device 80.

In the apparatus of the present invention, the viscosity of the sample of material to be tested can be measured with high precision. Unlike the conventional apparatus described beforehand, which has the torque measuring device coupled to the second end portion of the rotor shaft such that viscosity measurement is influenced by the condition of the seal ring on the rotor shaft, the torque measuring device 80 in the apparatus of the present invention is coupled to the inner mold portion 21 of the upper mold member 20 such that the measured viscosity is derived from the torque induced on the inner mold portion 21 and is not affected by the condition of the seal ring 14 on the rotor shaft 60.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An apparatus for measuring viscosity of a sample of material, comprising:
a mold assembly confining a chamber that is adapted to hold the sample of material to be tested therein, said mold assembly including upper and lower mold members, said lower mold member confining a lower mold cavity and being formed with an upwardly extending mold periphery and a shaft hole that is communicated with said lower mold cavity, said upper mold member being disposed above said lower mold member and confining an upper mold cavity that cooperates with said lower mold cavity to define said chamber, said upper mold member including an inner mold portion and an outer mold portion that is formed with a mold opening to receive said inner mold portion therein such that said inner mold portion is surrounded by said outer mold portion and is movable relative to said outer mold portion, said outer mold portion having a downwardly extending mold periphery that abuts tightly against said upwardly extending mold periphery of said lower mold member to form said chamber when said mold assembly is closed;
a rotor assembly including a rotor member disposed in said chamber, a rotor shaft having a first end portion coupled non-rotatably to said rotor member and a second end portion that extends sealingly through said shaft hole in said lower mold member, and a drive unit coupled to said second end portion of said rotor shaft for driving said rotor shaft to rotate, thereby driving said rotor member to rotate in said chamber such that the sample of material to be tested induces a torque on said inner mold portion of said upper mold member; and
a torque measuring device, coupled to said inner mold portion of said upper mold member, for measuring the amount of torque induced by the sample of material on said inner mold portion of said upper mold member when said rotor member rotates in said chamber;
whereby, the viscosity of the sample of material in said chamber can be determined from the amount of torque measured by said torque measuring device.

2. The apparatus of claim 1, further comprising a seal ring disposed between said inner and outer mold portions of said upper mold member.
